(19) United States
(12) Patent Application Publication
(10) Pub. No.: US 2024/0202380 A1
(43) Pub. Date: Jun. 20, 2024

(54) A METHOD OF DETERMINING A LAYOUT OF A WIND ENERGY PLANT

(71) Applicant: VESTAS WIND SYSTEMS A/S, Aarhus N (DK)

(72) Inventors: Michael PERKINS, South Yarra (AU); Buddhika ABEYRAMA, Croydon Hills (AU); Aaron LEASE, Portland, OR (US)

(21) Appl. No.: 18/554,689

(22) PCT Filed: Mar. 11, 2022
(86) PCT No.: PCT/DK2022/050045

§ 371 Date: Oct. 10, 2023

Related U.S. Application Data
(63) Continuation of application No. 17/227,279, filed on Apr. 10, 2021, now abandoned.

(51) Int. Cl. G06F 30/13; G06F 30/20; G06F 119/06; G06Q 50/06

(52) U.S. Cl. CPC G06F 30/13; G06F 30/20; G06Q 50/06; G06F 2119/06

(57) ABSTRACT

Techniques for determining a layout of a wind energy plant comprising a plurality of wind turbines at a site, where the wind turbines are configured for connection to a power grid having a power demand. Techniques include: providing an initial layout of wind turbines at initial positions within the site; obtaining site condition data for the initial layout; estimating an expected power output of the wind energy plant for a predetermined time period; forecasting the power demand within the power grid for the predetermined time period; performing an optimising process on the initial layout based on the estimated expected power output and on the forecasted power demand in order to match the expected power output to the forecasted power demand to obtain an optimised layout of the wind energy plant; and erecting the wind turbines in accordance with the optimised layout.

### FIELD OF THE DISCLOSURE

The present disclosure relates to a method of determining a layout of a wind energy plant.

### BACKGROUND OF THE DISCLOSURE

When planning a wind energy plant comprising a plurality of wind turbines to be erected within a given site, a siting process is normally performed. The siting process includes determining a layout of the wind energy plant, which defines the positions of the wind turbines within the site. The layout may further define which types of wind turbines to be applied at which positions within the site, and/or configurations of the wind turbines, e.g. including hub height, rotor diameter, nominal power, etc. Furthermore, the layout may define the total number of wind turbines to be positioned at the site.

The layout is determined with due to consideration to various constraints, such as boundaries of the site, unavailable areas within the site, e.g. lakes, woods, buildings, etc., specified number of wind turbines to be erected, specified types of wind turbines, etc. Given such constraints, the siting process seeks to define an optimal layout of the wind energy plant, in particular optimal positions for the wind turbines. The layout may be optimised with respect to various parameters, and very often the layout is optimised with regard to maximising capacity factor, i.e. the expected total power output or revenue of the wind energy plant during its entire lifetime.

However, when optimising the layout of a wind energy plant in the manner described above, the resulting wind energy plant may have a high power production during time periods where the need for power in the power grid is low and/or a low power production during time periods where the need for power in the power grid is high.

### DESCRIPTION OF THE DISCLOSURE

It is an object of embodiments of the disclosure to provide an improved method of determining a layout of a wind energy plant.

The disclosure provides a method of determining a layout of a wind energy plant comprising a plurality of wind turbines at a site, the wind turbines being configured for connection to a power grid having a power demand, the method comprising the steps of:
providing an initial layout by arranging the plurality of wind turbines at initial positions within the site;
obtaining site condition data for the initial positions of the plurality of wind turbines, wherein the site condition data comprises expected wind speed data;
estimating an expected power output of the wind energy plant based on the initial layout and on the site condition data for a predetermined time period;
forecasting the power demand within the power grid for the predetermined time period;
performing an optimising process on the initial layout based on the estimated expected power output and on the forecasted power demand in order to match the expected power output to the forecasted power demand to obtain an optimised layout of the wind energy plant; and
erecting the wind turbines in accordance with the optimised layout.

In the present context the term ‘wind energy plant’ should be interpreted to mean a plurality of wind turbines arranged within a specified geographical area; i.e. a site, where the wind turbines when erected will share some infrastructure, such as internal power grid, connection to an external power grid, substations, access roads, etc. When determining a layout of a wind energy plant comprising a plurality of wind turbines at a site, the positions of the individual wind turbines within the site are determined. If different types of wind turbines are available, the determination may further include a selection between different types of wind turbines for the wind energy plant. Alternatively or additionally, the configuration of the wind turbines may be selected, e.g. in terms of hub height, nominal power, rotor diameter, etc.

The wind turbines are configured for connection to a power grid having a power demand, which power demand may vary during the day and during the year. The power demand may further vary dependent on a power output from other sources, such as a power output of another wind energy plant and/or power output from other kinds of energy sources, such as conventional power plants, solar power plants, etc.

The method comprises a step of providing an initial layout by arranging the plurality of wind turbines at initial positions within the site. In one embodiment, the initial layout may be provided by randomly arranging the plurality of wind turbines within the site.

Site condition data for the initial positions of the plurality of wind turbines is obtained, which site condition data comprises expected wind speed data. The site condition data may as an example be based on measurement, based on forecasts, based on estimates, or combination of one or more of measurements, forecasts, and estimates. The site condition data may include data for a predetermined time period, such as the expected lifetime of the wind energy plant. Alternatively, the site condition may comprise data for a part of the expected lifetime, which period may repeated as part of the determination or may be extrapolated as part of the determination to provide site condition data for a predetermined time period, such as the expected lifetime of the wind energy plant.

The method comprises a step of estimating an expected power output of the wind energy plant based on the initial layout and on the site condition data for a predetermined time period, which predetermined time period may be the expected lifetime of the wind energy plant. In an alternative embodiment, the predetermined time period may by a year, part of a year, such as a month. The method may comprise a further step of extrapolating an estimated expected power output for a predetermined time period to a longer time period, where the longer time period may e.g. be a year, a plurality of year, the expected lifetime of the energy plant, etc.

Additionally, the method comprises a step of forecasting the power demand within the power grid for the predetermined time period where the power grid is an external power grid. The forecast may be based on the expected number of power consumers to which the power grid delivers power, expected number of housings, expected number and type of industry, hospitals, etc. The step of forecasting may consequently comprise an additional step of forecasting a change with regard to e.g. inhabitants, industry, etc. for the predetermined time period.

As the power demand may further vary dependent on a power output from other sources, such as a power output of another wind energy plant, solar energy, conventional power plants, etc., the step of forecasting the power demand within the power grid for the predetermined time period may further comprise a step of forecasting the power output from other sources.

When forecasting the power demand within the power grid, it may as an example be taken into account that solar energy plants primarily deliver power during sunny time periods, that production from conventional power plants can be downsized during time periods where the expected consumption it low and increased during time period with an expected consumption being high. Furthermore, the forecasting may take into account that especially the production from conventional power plants may be adjusted in response to varying energy costs.

An optimising process is performed on the initial layout based on the estimated expected power output and on the forecasted power demand in order to match the expected power output to the forecasted power demand to obtain an optimised layout of the wind energy plant.

The optimising process may comprise one or more step of estimating an expected power output of the wind energy plant based on an intermediate layout and on the site condition data, and forecasting the power demand within the power grid for the predetermined time period, where a first intermediate layout may be based on the expected power output for the initial layout, and a second intermediate layout may be based on the expected power output for the first intermediate layout.

The optimising process may be carried out until the best match between the expected power output and the forecasted power demand is achieved, where the best match may be defined as a match where the expected power output is sufficient to cover the forecasted power demand with the smallest amount of excess power output. This may be for a given time period, such as the predetermined time period, an alternative time period, such as on a yearly basis, such as for the lifetime of the wind energy plant. The optimising process may be carried out based on various constraints, such as boundaries of the site, unavailable areas within the site, e.g. lakes, woods, buildings, etc., specified number of wind turbines to be erected, specified types of wind turbines, a specified minimum distance between the wind turbines to be erected, etc.

The minimum distance may dependent on the type of wind turbine, hub height, rotor size, and expected weather conditions e.g. wind conditions. The minimum distance between the wind turbine may be set to minimise wake and flow related from one wind turbine to another and may alternatively and/or additionally be set as a minimum security-distance. Thus, a specified minimum distance may be included as a constraint together with boundaries, etc. The minimum distance may be set as a fixed distance for the site and may in an embodiment be kept as a fixed distance during the optimising process.

In one embodiment, the type and size of the wind turbines may be an additional constraint whereby the optimising process may primarily be a process of determining the individual position of each wind turbine and determining the number of wind turbines.

In an alternative embodiment, the type, size, and/or number of wind turbines may be determined as part of optimising process. It should be understood, that some constraints may be given with regard to type, size, and/ number, e.g. by providing only two different types of wind turbines of a specific height to be included in the optimising process.

Based on the constraints, the optimising process may define an optimal layout of the wind energy plant, in particular optimal positions for the wind turbines, in order to match the expected power output of the wind turbines of the layout to the forecasted power demand.

When the optimised layout is achieved, the wind turbines can be erected in accordance with the optimised layout.

The step of performing the optimising process may comprise a step of changing the position of at least one of the wind turbines. The position may be changed for a plurality of the wind turbines, as an example by changing the position of only one at a time, or by changing the position for two or more wind turbines simultaneously and subsequently estimating an expected power output of the wind energy plant based on the amended layout and forecasting the power demand within the power grid for the predetermined time period, where the amended layout may be an intermediate layout in the process achieving the optimised layout or the amended layout may be the optimised layout which has been achieved by the amendment(s).

The step of performing the optimising process may additionally or alternative comprise a step exchanging the type of wind turbine for at least one of the wind turbines. Additionally or alternatively, the hub height may be changed for at least one of the wind turbines.

The optimising process may be a process of optimising a plurality of parameters simultaneously or optimising a plurality of parameters in a single process. This may be achieved by initially determining the different constraints, such as boundaries of the site, unavailable areas within the site, e.g. lakes, woods, buildings, etc., a specific number of wind turbines to be erected, or a range of available number of wind turbines, specific type or types of wind turbines, minimum distance, etc. When the constraints have been determined, the optimising process may change and/or scale the different variables to achieve the optimal layout.

In an alternative embodiment, the optimising process may be a stepwise process. As an example, a first optimising step may include changing the position of one of the wind turbines, a second optimising step may include changing the hub height of a second wind turbine, a third optimising step may include changing the position of a third wind turbine, a fourth step may include changing the position of the first wind turbine, etc.

The step of performing the optimising process may further comprise a step of obtaining site condition data for the changed position of the at least one wind turbine. Consequently, it may be possible to estimate an expected power output of the wind energy plant based on the amended layout and on the changed site condition data for a predetermined time period to thereby improve the optimising process. If the change of position is limited, the site condition data may be reused.

In one embodiment, the site condition data may further comprise estimated wind direction data. The wind speed data and wind direction data may be correlated pairs of data, where each pair of site condition data may comprise a wind speed value and an associate wind direction value. The pairs of data may further comprise a time stamp identifying e.g. time of the day and time of the year to the respective pairs. By including wind direction data, a dominant wind direction may be determined. In one embodiment, the dominant wind direction may be included in the step of providing the initial layout.

The site condition data may additionally comprise one or more of the following; turbulence conditions, wind shear, ambient temperature, humidity, precipitation, air density, pressure, etc.

The site condition data may be based at least partly on meteorological data obtained at the site during a measurement period. The meteorological data may be obtained by means of sensors or other measurement devices, such as anemometers, mounted at the site prior to the planning of the layout. Alternatively or additionally, the meteorological data may be obtained by means of met masts located within the site or in the vicinity of the site, and/or from meteorological services, e.g. satellite based meteorological services.

The measurement period may be a year, one or two months during different seasons, e.g. a month with typical low wind speed and a month with typical high wind speed, or an even longer time period. The measurement data obtained during the measurement period may be extrapolated to a longer time period, such the expected lifetime for the wind energy plant. The extrapolation may be based on statistical data for the site. The statistical data may be less detailed relative to positions within the site than the meteorological data obtained during the measurement period.

Thus, the site condition data may be based at least partly on meteorological data obtained at the site during a measurement period being at least one year. The data may be extrapolated to cover a longer time period, such as the lifetime of the wind energy plant.

The site condition data may represent variations as a function of time of year to thereby provide site condition data for e.g. a windy time period and a less windy time period, during the course of a year.

Alternatively or additionally, the site condition data may represent variations as a function of time of day.

In one embodiment, site condition data may be provided for each hour of a year, such as statistically determined yearly site condition data, cf. table 1 below.

TABLE 1
Site Condition Data (SCD) for every
hour of a typical day for each month.

| | January | February | . . . | December |
|---|---|---|---|---|
| 0:00 | SCD1 | SCD25 | . . . | SCD265 |
| 1:00 | SCD2 | SCD26 | . . . | SCD266 |
| . . . | . . . | . . . | . . . | . . . |
| 23:00 | SCD24 | SCD28 | . . . | SCD288 |

In one embodiment, the forecasted power demand within the power grid may likewise be provided as a function of time of year and/or as a function of time of day. Thus, the forecasted power demand within the power grid may be provided for each hour of a year, cf. table 2 below.

TABLE 2
Forecasted power demand (FPD) within the grid
for every hour of a typical day for each month.

| | January | February | . . . | December |
|---|---|---|---|---|
| 0:00 | FPD1 | FPD25 | . . . | FPD265 |
| 1:00 | FPD2 | FPD26 | . . . | FPD266 |
| . . . | . . . | . . . | . . . | . . . |
| 23:00 | FPD24 | FPD28 | . . . | FPD288 |

The step of estimating the expected power output of the wind energy plant may be based on site condition data as represented in Table 1, whereas the step of forecasting the power demand within the power grid may be carried out to provide data as represented in Table 2. It should be understood that at least one of the site condition data and the forecasted power demand within the grid may be provided in accordance with an alternative time schedule, e.g. for every 30 minutes or for every second hour.

The step of providing an initial layout may be based on at least one of historical meteorological data and terrain data, where the terrain data may represent the physical features of the site, and may comprise information regarding the vertical and horizontal dimension of the land surface. This may be expressed in terms of the elevation, roughness, slope, orientation of terrain features, etc. The terrain features may comprise, but are not limited to, hills, ridges, valleys, saddles, cliffs, vegetation, lakes, etc. As an example, the historical meteorological data may include the dominant wind direction.

The step of estimating the expected power output of the wind energy plant may comprise a step of estimating an expected power output of each of the wind turbines individually to thereby achieved a more detailed estimate for the expected power output.

### BRIEF DESCRIPTION OF THE DRAWINGS

Embodiments of the disclosure will now be further described with reference to the drawings, in which:

FIG. 1 illustrates a diagrammatic view of a wind energy plant;

FIG. 2 illustrates an initial layout of a wind energy plant;

FIG. 3 illustrates an intermediate layout of a wind energy plant;

FIG. 4 illustrates an optimised layout of a wind energy plant; and

FIG. 5 is a flow chart illustrating of an embodiment of the method.

### DETAILED DESCRIPTION OF THE DRAWINGS

It should be understood that the detailed description and specific examples, while indicating embodiments of the disclosure, are given by way of illustration only, since various changes and modifications within the spirit and scope of the invention will become apparent to those skilled in the art from this detailed description.

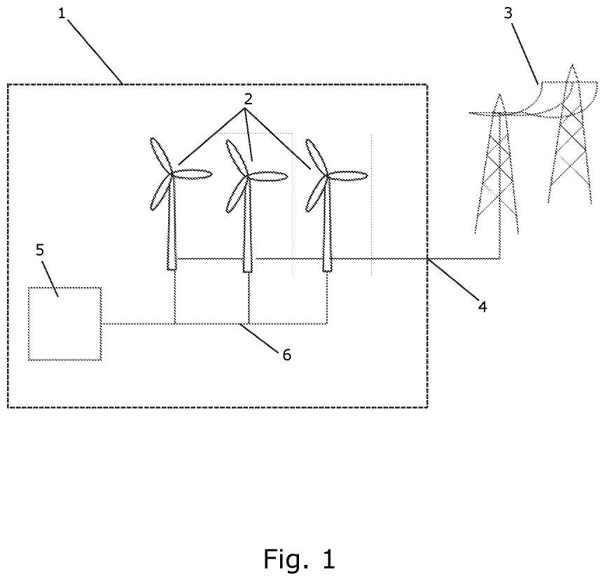

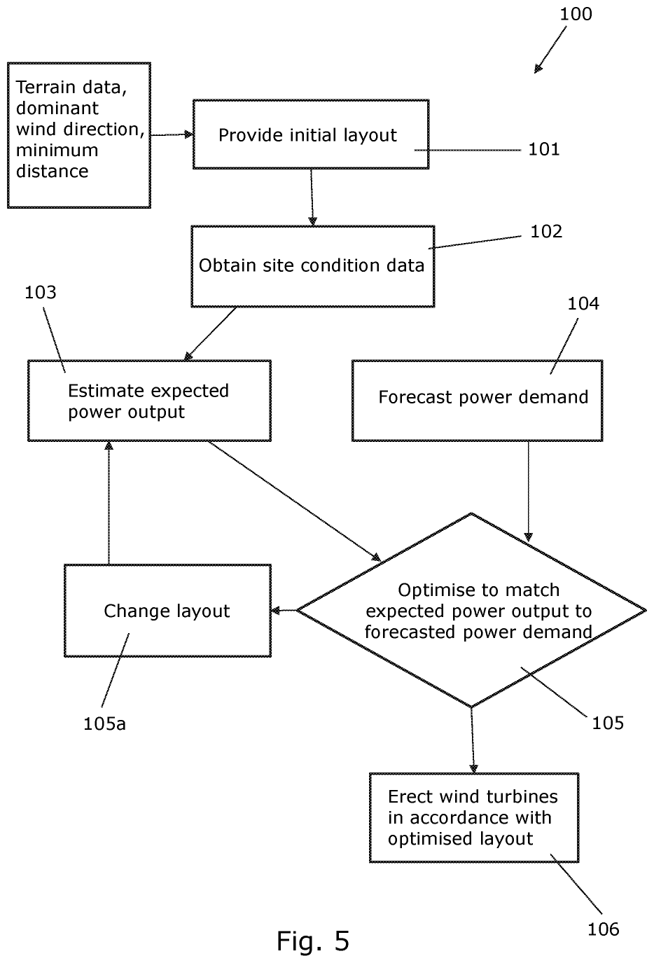

FIG. 1 is a diagrammatic view of a wind energy plant 1 comprising a plurality of wind turbines 2, three of which are shown. The wind turbines 2 are connected to a power grid 3 via a point of common coupling 4. Accordingly, the power produced by the wind turbines 2 is supplied to the power grid 3. The wind energy plant 1 is erected in accordance with the method schematically illustrated by the flow chart 100 in FIG. 5.

The wind turbines 2 are further connected to a central unit 5 via a communication connection 6, thereby allowing data collected at the wind turbines 2 to be communicated to the central unit 5. The central unit 5 may comprise a central data hub of the wind energy plant 1, a SCADA system, a power plant controller (PPC), or any other suitable kind of central unit for control and/or supervision of the wind turbines.

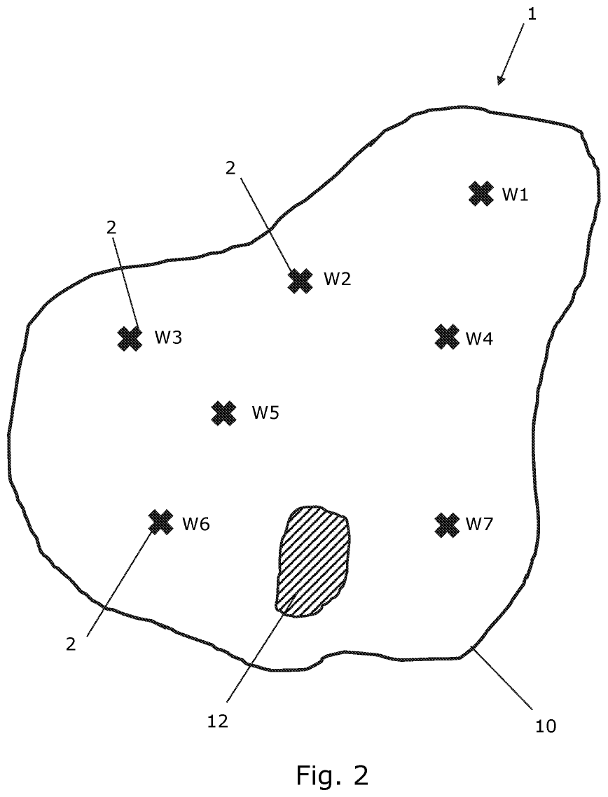

FIG. 2 illustrates an initial layout of a wind energy plant 1 comprising a total of seven wind turbines 2 at a site 10. A lake 12 is also located at the site 10. Each of the seven wind turbines 2 are marked as a cross and denoted W1, W2, W3, W4, W5, W6, and W7, respectively.

The initial layout illustrated in FIG. 2 is provided by randomly arranging the plurality of wind turbines within the site while considering the terrain to avoid positioning of a wind turbine 2 in the lake 12 and while considering the dominant wind direction. Additionally, the constrains, such as site conditions including unavailable areas within the site, e.g. lakes, woods, buildings, etc., a specific number of wind turbines to be erected, or a range of available number of wind turbines, specific type or types of wind turbines, etc., are determined and used as basis for the optimising process. Furthermore, a minimum distance between the wind turbines is included as basis for the optimising process. This distance may dependent on the type of wind turbine, hub height, rotor size, and expected weather conditions e.g. wind conditions.

An optimising process is performed on the initial layout as illustrated in FIG. 2 based on the estimated expected power output of the wind turbines 2 and on the forecasted power demand of the power grid in order to match the expected power output to the forecasted power demand to obtain an optimised layout of the wind energy plant.

In the illustrated embodiment, the optimising process comprises one or more step of estimating an expected power output of the wind energy plant based on an intermediate layout and on the site condition data, and forecasting the power demand within the power grid for the predetermined time period, where a first intermediate layout may be based on the expected power output for the initial layout, and a second intermediate layout may be based on the expected power output for the first intermediate layout.

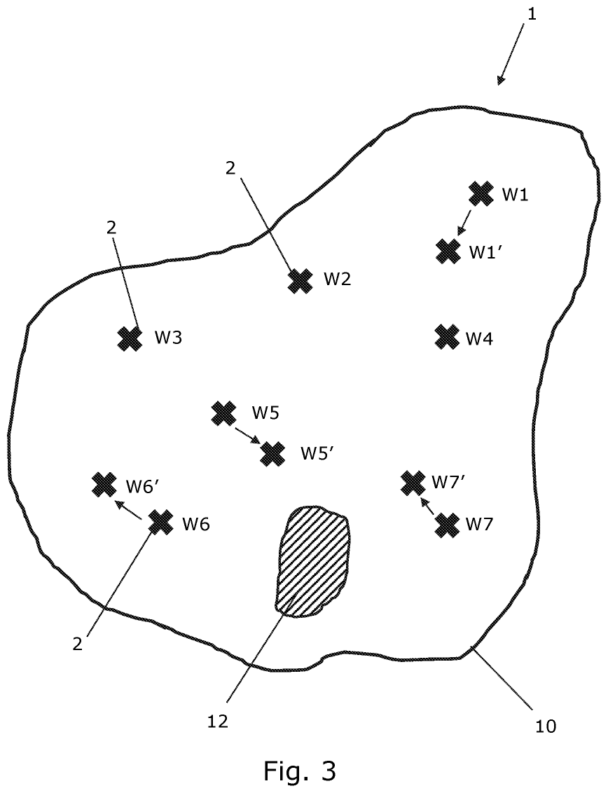

A first intermediate layout of the wind energy plant 1 is illustrated in FIG. 3. In the intermediate layout, the position of wind turbine W1 has been changed to W1′. Likewise, is the position of the wind turbines W5, W6, and W7 changed to W5′, W6′, and W7′, respectively, as indicated by the arrows. The positions of the wind turbines W2, W3 and W4 are unchanged, i.e. the positions of these wind turbines are not moved relative to the position of the initial layout illustrated in FIG. 2.

The optimising process is carried out until the best match between the expected power output and the forecasted power demand is achieved.

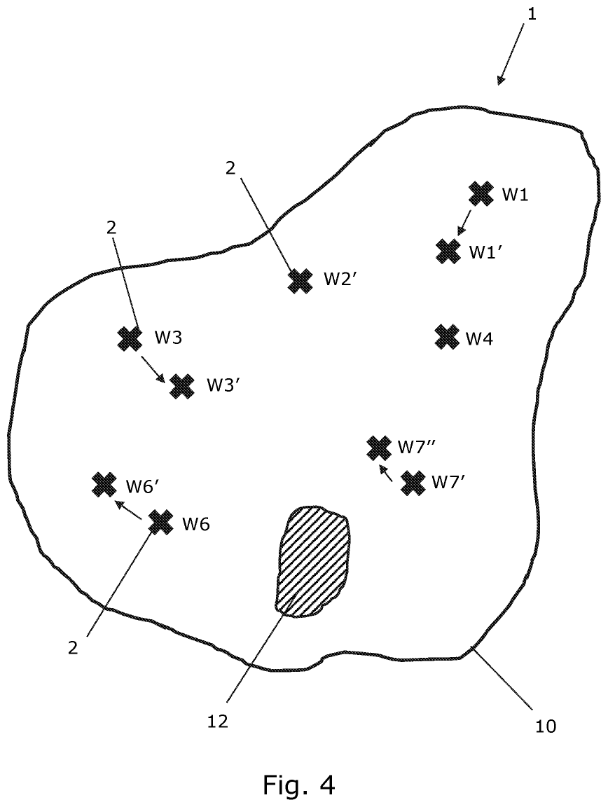

FIG. 4 illustrates an optimised layout of a wind energy plant 1. The position of wind turbines W1′, W6′, and W4 are unchanged, whereas the position of wind turbine W7′ has been changed further to W7″. Wind turbine W2 has been substituted by another type of wind turbine W2′, and wind turbine W5 has been cancelled.

When the optimised layout is achieved, the wind turbines 2 can be erected in accordance with the optimised layout to thereby provide a wind energy plant 1 as illustrated in FIG. 1.

FIG. 5 is a flow chart 100 of an embodiment of the method. The method is initiated in step 101, in which an initial layout is provided by arranging the plurality of wind turbines 2 (see FIGS. 2-4) at initial positions within the site 10 (see FIG. 2-4). The step 101 is based at least partly on terrain data, e.g. to avoid that a wind turbine is arranged in a lake or in a deep cleft, on the dominant wind direction, and on a determined minimum distance between the wind turbines.

In step 102, site condition data is obtained for the initial positions of the plurality of wind turbines. The site condition data comprises at least expected wind speed data. Additionally, the site condition data may comprise one or more of wind direction, turbulence conditions, wind shear, ambient temperature, humidity, precipitation, air density, and pressure. The site condition data may represent variations as time of year and variations as a function of time of day, as exemplified in Table 1.

In step 103, an expected power output of the wind energy plant based on the initial layout and on the site condition data is estimated for a predetermined time period.

In step 104, a power demand within the power grid is forecasted for the predetermined time period. The forecast is based on the expected power consumers, e.g. in terms of expected number of inhabitants to which the power grid delivers power, expected number of housings, expected number and type of industry, hospitals, etc., including a step of forecasting a change with regard to e.g. inhabitants, industry, etc. for the predetermined time period. Furthermore, the step of forecasting the power demand within the power grid for the predetermined time period further comprises a step of forecasting the power output from other sources delivering power to the power grid.

In step 105, an optimising process is performed on the initial layout based on the estimated expected power output and on the forecasted power demand in order to match the expected power output to the forecasted power demand to obtain an optimised layout of the wind energy plant.

The step 105 of performing the optimising process may comprise an additional step 105a of changing the position of at least one of the wind turbines and/or a step exchanging the type of wind turbine for at least one of the wind turbine and/or a step of changing the hub height for at least one of the wind turbines and/or cancel a wind turbine and/or include an extra wind turbine to thereby change the layout. Subsequently, an expected power output may be estimated for the changed layout in step 103.

In step 106, wind turbines are erected in accordance with the optimised layout, thereby providing a wind energy plant 1 as illustrated in FIG. 1.

1. A method of determining a layout of a wind energy plant comprising a plurality of wind turbines at a site, the wind turbines being configured for connection to a power grid having a power demand, the method comprising:
providing an initial layout by arranging the plurality of wind turbines at initial positions within the site;
obtaining site condition data for the initial positions of the plurality of wind turbines, wherein the site condition data comprises expected wind speed data;
estimating an expected power output of the wind energy plant based on the initial layout and on the site condition data for a predetermined time period;
forecasting the power demand within the power grid for the predetermined time period;
performing an optimising process on the initial layout based on the estimated expected power output and on the forecasted power demand in order to match the expected power output to the forecasted power demand to obtain an optimised layout of the wind energy plant; and
erecting the wind turbines in accordance with the optimised layout.

2. The method of claim 1, wherein the performing the optimising process comprises a step of changing the position of at least one of the wind turbines.

3. The method of claim 2, wherein the performing the optimising process further comprises a step of obtaining site condition data for the changed position of the at least one wind turbine.

4. The method of claim 1, wherein the site condition data further comprises estimated wind direction data.

5. The method of claim 1, wherein the site condition data is based at least partly on meteorological data obtained at the site during a measurement period.

6. The method of claim 5, wherein the measurement period is at least one year.

7. The method of claim 1, wherein the site condition data represents variations as a function of time of year.

8. The method of claim 1, wherein the site condition data represents variations as a function of time of day.

9. The method of claim 1, wherein the providing an initial layout is based on at least one of historical meteorological data and terrain data.

10. The method of claim 1, wherein the estimating the expected power output of the wind energy plant comprises a step of estimating an expected power output of each of the wind turbines individually.

11. A method of determining a layout of a wind energy plant comprising a plurality of wind turbines at a site, the wind turbines being configured for connection to a power grid having a power demand, the method comprising:
estimating an expected power output of the wind energy plant based on at least two inputs for a predetermined time period; the at least two inputs comprising:
an initial layout of the plurality of wind turbines arranged at initial positions within the site; and
site condition data for the initial positions of the plurality of wind turbines, wherein the site condition data comprises expected wind speed data;
forecasting the power demand within the power grid for the predetermined time period; and
generating an optimised layout of the wind energy plant by performing an optimising process on the initial layout based on the estimated expected power output and on the forecasted power demand in order to match the expected power output to the forecasted power demand.
